(19) United States
(12) Patent Application Publication
(10) Pub. No.: US 2002/0194491 A1
(43) Pub. Date: Dec. 19, 2002

(54) Method and system for reducing traffic in a channel of communication while protecting user privacy

(75) Inventors: Assaf Natanzon, Ramat Aviv (IL); Hayim Shaul, Bat-Yam (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: EXPAND NETWORKS LTD.

(21) Appl. No.: 10/105,356

(22) Filed: Mar. 26, 2002

Related U.S. Application Data
(60) Provisional application No. 60/280,120, filed on Apr. 2, 2001.

(51) Int. Cl. H04L 9/00

(52) U.S. Cl. 713/200

(57) ABSTRACT

Methods and system for increasing the operational efficiency of a server while protecting user privacy. One method includes defining a universal reference file to use in response to queries, transmitting sufficient information to generate a first response file following receipt of a query from a user and responding to a second query from the same user by transmitting a current differences file. An additional method includes defining an initial reference file, comparing a response to a query to the initial reference file, deleting content which is not common to the current response and the initial reference file to generate an updated reference file containing less user specific information, transmitting sufficient information to generate the updated reference file and a response to a current query to a specific user and responding to a second query from the same user by supplying a differences file so that a second response file may be generated. The updated reference file serves as an initial reference file for a subsequent request. Automated systems for practice of the methods are further disclosed.

This application claims priority from U.S. Provisional Patent Application No. 60/280,120 filed on Apr. 2, 2001.

### FIELD AND BACKGROUND OF THE INVENTION

The present invention relates to a method and system for reducing traffic in a channel of communication while protecting user privacy and, more particularly, to a system and method for protecting user privacy by creating reference files.

The increased use of the Internet has created an unprecedented demand for data transfer. As a result, many commercial content providers find that their servers are overloaded by an unanticipated number of requests for content.

This causes delays for users between submission of a query (request for content) from a user and receipt of a response by the user. Solutions to the delay problem must rely on either increased bandwidth, compression of transferred data, or reduction of the amount of data transferred in response to each query.

A number of high bandwidth solutions exist. These include, but are not limited to ISDN and T1 connections. These solutions generally require purchase of hardware and installation thereof. Equipment upgrades carry a risk of system failure or interruptions in service, adding the cost of lost business Therefore, the cost of implementing a high bandwidth solution effectively eliminates this option for many commercial content providers.

Compression of transferred data provides a partial solution. However, implementation of such a solution requires that a content provider compress requested content resource and a recipient uncompress the received content resource. Thus, while transfer speed per se is always increased, the amount of time processing a request at each end may actually increase.

Therefore, reduction of the amount of data transferred in response to a query offers significant advantages with respect to the above-mentioned techniques. Since many commercial content providers process large numbers of similar requests for content each day, a significant portion of the response to each request is common to all, or many, of the requests. Unfortunately, the information which is different is generally user specific. Therefore, using a standard reference file with an accompanying differences file is currently not advisable because it tends to compromise user privacy.

There is thus a widely recognized need for, and it would be highly advantageous to have, a method and system for reducing traffic in a channel of communication while protecting user privacy. A system and method for protecting user privacy by creating reference files is suggested as a means of fulfilling this need.

### SUMMARY OF THE INVENTION

According to one aspect of the present invention there is provided a method for increasing the operational efficiency of a server functioning as a content provider. The method includes: (a) defining a universal reference file , the reference file for use in response to queries from a plurality of users; (b) transmitting sufficient information to generate a first response file following receipt of a query from a user belonging to the plurality of users; and (c) responding to a second query from the user by transmitting a current differences file containing sufficient information to generate a second response file from the universal reference file.

According to another aspect of the present invention there is provided a system for increasing the operational efficiency of a content provider. The system includes a server. The server is designed and configured for: (i) defining a universal reference file, the universal reference file for use in response to queries from a plurality of users; (ii) transmitting sufficient information to generate a first response file following receipt of a query from a user belonging to the plurality of users; (iii) responding to a second query from the user by supplying a current differences file containing sufficient information to generate a second response file from the universal reference file.

According to yet another aspect of the present invention there is provided a method for protecting user privacy while creating reference files to use in response to a query. The method includes: (a) defining an initial reference file for use in response to queries from a plurality of users; (b) comparing a response to a current query to the initial reference file; (c) deleting any content which is not common to the response to a current query and the initial reference file to generate an updated reference file, wherein the updated reference file contains less user specific information than the initial reference file; (d) transmitting sufficient information to generate the updated reference file and a response to a current query to a specific user belonging to the plurality of users; and (e) responding to a second query from the specific user by supplying a differences file so that a second response file may be generated from the updated reference file. The updated reference file then serves as the initial reference file for a subsequent request.

According to still another aspect of the present invention there is provided a system for protecting user privacy by creating reference files to use in response to a query. The system includes a server designed and configured for: (a) defining an initial reference file for use in response to queries from a plurality of users; (b) comparing a response to a current query to the initial reference file; (c) deleting any content which is not common to the response to a current query and the initial reference file to generate an updated reference file so that the updated reference file contains less user specific information than the initial reference file; (d) transmitting sufficient information to generate the updated reference file and a response to a current query to a specific user belonging to the plurality of users; and (e) responding to a second query from the specific user by supplying a differences file so that a second response file may be generated from the updated reference file. The updated reference file then serves as the initial reference file for a subsequent request.

According to further features in preferred embodiments of the invention described below, transmitting sufficient information includes transmitting the universal reference file and a first differences file.

According to still further features in the described preferred embodiments transmitting sufficient information includes transmitting the first response file and a first differences file. This allows a recipient client to generate the universal reference file from the transmitted information.

According to still further features in the described preferred embodiments the sufficient information includes the reference file and a differences file According to still further features in the described preferred embodiments the sufficient information includes a response file and a differences file so that the reference file is generatable therefrom.

According to still further features in the described preferred embodiments defining the initial reference file is accomplished by identifying information common to responses to at least two queries.

According to still further features in the described preferred embodiments the updated reference file is devoid of user specific information.

According to still further features in the described preferred embodiments transmitting sufficient information includes transmitting the updated reference file and a differences file.

According to still further features in the described preferred embodiments transmitting sufficient information includes transmitting the response to a current query and a differences file, wherein the updated reference file is generatable therefrom.

According to still further features in the described preferred embodiments the initial reference file is defined by identifying information common to responses to at least two queries.

According to still further features in the described preferred embodiments the updated reference file is devoid of user specific information.

According to still further features in the described preferred embodiments the sufficient information includes the updated reference file and a differences file.

According to still further features in the described preferred embodiments sufficient information includes the response to a current query and a differences file, wherein the updated reference file is generatable therefrom.

The present invention successfully addresses the shortcomings of the presently known configurations by providing methods and systems for reducing the data transfer burden on a content providing server while protecting user privacy.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow diagram illustrating data processing and transfer in a method according to the present invention.

FIG. 2 is a schematic representation of a system according to the present invention.

### DESCRIPTION OF THE PREFERRED EMBODIMENTS

The present invention is of a methods and systems which can reduce traffic in a channel of communication while protecting user privacy. Specifically, the present invention employs reference files and difference files to transfer data in a network. As will be detailed hereinbelow, this serves to both reduce the volume of data transmitted in response to a query and to protect privacy of users operating user clients in a network.

The principles and operation of methods and systems according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims the term “application” refers to any algorithm for performing at least one function on a computing device. The term specifically includes, but is not limited to, word processors, web browsers, e-mail managers, date books, notepads, address books, music players, animation players, video players, games and viewers.

For purposes of this specification and the accompanying claims, the phrase “user client” generally refers to a computer and includes, but is not limited to, personal computers (PC) having an operating system such as DOS, Windows™, OS/2™ or Linux; Macintosh™, Palm OS™, EPOC™ computers; computers having JAVA™-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system; personal digital assistants (PDA), cellular telephones having computer capabilities, a telephone having computer capabilities and Web TVs, each of which is known to include an inherent or connectable display device. A user client is characterized as having at least one input device and at least one output device.

For purposes of this specification and the accompanying claims, the term “server” refers to any computing machine capable of exchanging data with at least one other computing machine. A single server may comprise an individual computing machine or a plurality of such machines acting in concert to perm a function requested by at least one other computing machine.

For purposes of this specification and the accompanying claims, the term “Windows™” includes but is not limited to Windows 95™, Windows 2000™ Windows 3.x™ in which “x” is an integer such as “1”, Windows NT ™, Windows 98™, Windows CE™ Windows Millennium™ and any upgraded versions of these operating systems by Microsoft Corp (USA) and/or window managers for the graphical X Windows system for UNIX based operating systems and/or its variants such as Linux.

For purposes of this specification and the accompanying claims, the phrase “computing platform” refers to any particular operating system and/or hardware device, as previously described, according to which the format for data communication and/or presentation (display) thereof is determined.

For purposes of this specification and the accompanying claims, the term “data” refers to digital data including, but not limited to a software program, a text file, a sound file, a file containing at least one video image, and an animation sequence as well as to any combinations thereof.

For purposes of this specification and the accompanying claims, the phrase “channel of communication” includes, but is not limited to a telephone connection, a cellular telephone connection, an Internet connection, an infrared frequency transmission connection, a local area network connection, a radio frequency connection, a fiber-optic connection or a connection by a wire. Inherent in the idea of a communication channel is an open status during which data transmission may occur. In some cases, communication channels may also have a closed status during which no data transmission may occur. The phrase is to be construed in its broadest possible sense so that it encompasses any mode of data transfer.

For purposes of this specification and the accompanying claims the phrase “software program” refers to any algorithm for performing at least one function on a computing device. The term specifically includes, but is not limited to web browsers, music players, animation players, video players, games, compression algorithms, search programs, client to client interfaces and viewers.

For purposes of this specification and the accompanying claims the phrase “display device” refers to any device for presentation of data to a user. The definition includes, but is not limited to speakers, earphones, LCD screens, LED displays, CRT displays and active matrix displays. For purposes of this specification and the accompanying claims the phrase “input device” refers to any device for entry of data to a computing device. The definition includes, but is not limited to a keyboard, a computer mouse, a track pad, a track ball, a stylus, a touch screen, a camera and a microphone.

For purposes of this specification and the accompanying claims, the phrase “Web browser” or “browser”, unless otherwise indicated, refers to any software program which can display text, graphics, or both, as well as display video, and/or play sounds, from Web pages on World Wide Web sites and or local files.

For purposes of this specification and the accompanying claims, the phrase “Web page” refers to any document written in a “mark-up language”, or “script language”, or any programming language or tool. For purposes of this specification and the accompanying claims, the phrase “mark up language” includes, but is not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator). Script languages include, but are not limited to, CGI, PERL, VBScript, JavaScript, and ASP.

For purposes of this specification and the accompanying claims, the term “entity” refers to any company, organization or private individual or a collection or combination thereof.

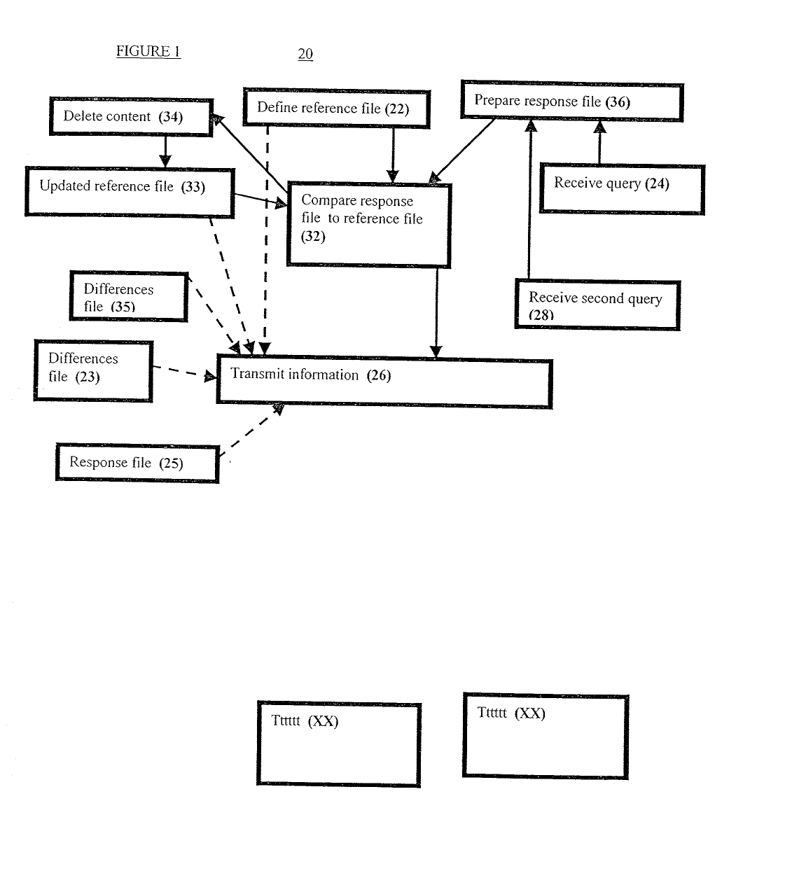

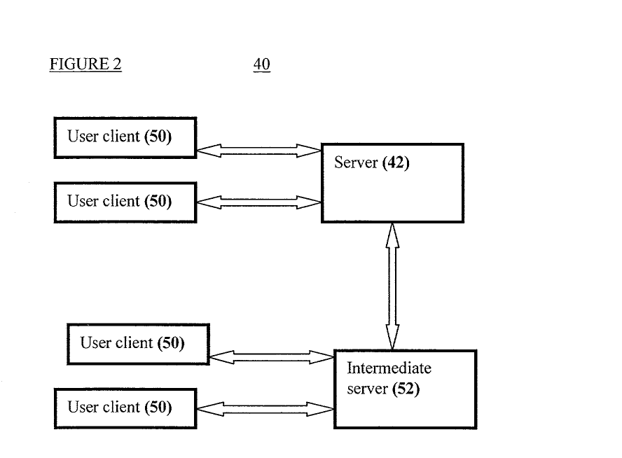

Referring now to the drawings, FIG. 1 illustrates a method 20 for increasing the operational efficiency of a server functioning as a content provider. Method 20 includes defining 22 a universal reference file for use in response to queries from a plurality of users operating user clients 50 (FIG. 2).

Method 20 further includes transmitting 26 sufficient information to generate a first response file 25 following receipt of a query (24) from a user belonging to the plurality of users operating user clients 50. The sufficient information may include, for example, the universal reference file (e.g. 33) and a first differences file 23. In this case, the response file is regenerated at user client 50 by applying the specified differences to reference file 33. Alternately, the sufficient information may include, for example, the first response file 25 and a first differences file 23. In this case, a recipient user client generates the universal reference file (e.g. 33) from the transmitted information and stores it for future use.

Method 20 further includes responding to a second query 28 from the user by transmitting a current differences 35 file containing sufficient information to generate a second response file from the universal reference file. It will be appreciated that while the volume of data transmitted through the channel of communication in response to first query 24 may be of a size equal to response file 25, differences file 35 transmitted in response to second query 28 will be considerably smaller than a second response file. This serves to increase the operational efficiency of server 42 functioning as a content provider as well as intermediate servers 52 by reducing the volume of data transferred across channels of communication (hollow arrows; FIG. 2). In addition, interception of data destined for a specific user client 59, by a third party will be less likely to compromise the privacy of a user. This is because the majority of data transmissions will include only differences files (e.g. 35). A differences file without an accompanying reference file will be very difficult to interpret.

The present invention is further embodied by a system 40 (FIG. 2) for increasing the operational efficiency of a content provider. The system includes a server 42. Server 42 is designed and configured for implementing a method as described hereinabove. Specifically, server 42 receives queries (e.g. 24 and 28) and transmits data to user clients 50. The transmitted data, as described hereinabove, is sufficient to allow user client 50 to reconstruct a response file, although a response file per-se is not always transmitted. This is accomplished by the use of reference files and difference files, as described hereinabove. Communication between server 42, intermediate server 52 and user clients 50 may be by any available channel of communication as defined hereinabove. Typically, user clients 50, will transmit queries (e.g. 24 and 28) by means of a graphical user interface, for example a browser. As such, responses will generally be web pages viewable upon a display of user client 50.

The present invention is further embodied by a second method 20 for protecting user privacy while creating reference files to use in response to a query. Method 20 includes defining 22 an initial reference file for use in response to queries from a plurality of users operating user clients 50. Method 20 further includes comparing 32 a response 36 to a current query (e.g. 24) to the initial reference file and deleting 34 any content which is not common to the response to a current query and the initial reference file to generate an updated reference file 33. In this way, updated reference file 33 contains less user specific information than initial reference file 22.

Method 20 further includes transmitting 26 sufficient information to generate the updated reference file 33 and a response to a current query 25 to a specific user operating user client 50. According to method 20, responding to a second query 28 from the same specific includes supplying only a differences file 35 so that a second response file 25 may be generated from updated reference file 33. Updated reference file 33 then serves as initial reference file 22 for a subsequent request.

Preferably, defining 22 the initial reference file is accomplished by identifying information common to responses to at least two queries. For example, if server 42 belongs to a bank which offers Internet banking services, all responses might include the logo of the bank, bank contact information and field headers such as account number, name, address, date transaction number and amount. Repeated comparison 32 of generated response files eventually eliminates all data from the reference file except for this universal information. Universal, as used herein, does not necessarily indicate permanent. For example, the date field contains data which only remains universal for 24 hours. Thus, according to preferred embodiments of the invention, updated reference file 33 is devoid of user specific information.

Transmitting 26 sufficient information may include, for example, transmitting the updated reference file 33 and a differences file 23. In this case, user client 50 re-generates a response file by applying the differences to the reference file.

Alternately, transmitting 26 sufficient information may include, for example, transmitting a response to a current query 25 and a differences file 23. In this case, updated reference file 33 is generated by applying differences to response 25.

In either case, a subsequent query from the same user results in transmission of only a differences file 35, which is applied to reference file 33 already stored on user client 50.

The present invention is further embodied by a second system 40 for protecting user privacy by creating reference files to use in response to a query. Second system 40 includes a server designed and configured for implementation of second method 20 as described hereinabove.

The present invention is expected to find utility primarily, but not exclusively, in two contexts. The first context is a server 42 which receives multiple queries from the same user over a period of time for a web page which has many constant graphical features. An example of this context is an Internet version of a newspaper. The entry portal for such a newspaper might include, for example a headline, a date, a list of headings, (e.g. local, national, international, sports, weather, fashion, entertainment, classifieds, etc.), a few headlines serving as hyperlinks to articles and one or two photographs. Only the date, headlines and photo are expected to change daily. Thus, if readers store reference file 33 on user clients 50, server 42 transmits 26 a much smaller volume of data in response to each request.

The second context is a server 42 which transmits private user specific information, for example credit card statements. Again, the majority of responses to queries will share a great deal material such as company logo, contact information and field names. Thus, if users store reference file 33 on user clients 50, server 42 may transmits 26 differences files (e.g. 35 or 23) in response to each request. This means that a response, instead of including the users credit card number, might include 16 difference instructions.

| | | | | |
|---|---|---|---|---|
| Thus a user with card number: | 1234 | 5678 | 9123 | 4567 |
| and card number in reference file 33: | 2255 | 5799 | 0033 | 7654 |
| receives differences for card number: | 9089 | 0989 | 9190 | 7913 |

An algorithm operating on user client 50 adds the numbers in the differences file assigned to card number to the reference file card number. According to these preferred embodiments, server 42 will maintain a database of users and reference files 33. Server 42 is presumably secure. However, transmitted data 26 may remain on one or more intermediate servers 52 where it can be intercepted by a third party. Thus, the present invention effectively encrypts user specific information by requiring use of a separately transmitted reference file, thereby protecting user privacy.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for increasing the operational efficiency of a server functioning as a content provider, the method comprising:
(a) defining a universal reference file, said reference file for use in response to queries from a plurality of users;
(b) transmitting sufficient information to generate a first response file following receipt of a query from a user belonging to said plurality of users; and
(c) responding to a second query from said user by transmitting a current differences file containing sufficient information to generate a second response file from said universal reference file.

2. The method of claim 1, wherein transmitting sufficient information includes transmitting said universal reference file and a first differences file.

3. The method of claim 1, wherein transmitting sufficient information includes transmitting said first response file and a first differences file, wherein said universal reference file is generatable therefrom.

4. A system for increasing the operational efficiency of a content provider, the system comprising:
a server, said server designed and configured for:
(i) defining a universal reference file, said universal reference file for use in response to queries from a plurality of users;
(ii) transmitting sufficient information to generate a first response file following receipt of a query from a user belonging to said plurality of users;
(iii) responding to a second query from said user by supplying a current differences file containing sufficient information to generate a second response file from said universal reference file.

5. The system of claim 4, wherein said sufficient information includes said reference file and a differences file.

6. The system of claim 4, wherein said sufficient information includes a response file and a differences file, wherein said reference file is generatable therefrom.

7. A method for protecting user privacy while creating reference files to use in response to a query, the method comprising:
(a) defining an initial reference file for use in response to queries from a plurality of users;
(b) comparing a response to a current query to said initial reference file;
(c) deleting any content which is not common to said response to a current query and said initial reference file to generate an updated reference file, wherein said updated reference file contains less user specific information than said initial reference file;
(d) transmitting sufficient information to generate said updated reference file and a response to a current query to a specific user belonging to said plurality of users; and
(e) responding to a second query from said specific user by supplying a differences file so that a second response file may be generated from said updated reference file;
wherein said updated reference file serves as said initial reference file for a subsequent request.

8. The method of claim 7, wherein defining said initial reference file is accomplished by identifying information common to responses to at least two queries.

9. The method of claim 7, wherein said updated reference file is devoid of user specific information.

10. The method of claim 7, wherein transmitting sufficient information includes transmitting said updated reference file and a differences file.

11. The method of claim 7, wherein transmitting sufficient information includes transmitting said response to a current query and a differences file, wherein said updated reference file is generatable therefrom.

12. A system for protecting user privacy by creating reference files to use in response to a query, the system comprising a server designed and configured for:
(a) defining an initial reference file for use in response to queries from a plurality of users;
(b) comparing a response to a current query to said initial reference file;
(c) deleting any content which is not common to said response to a current query and said initial reference file to generate an updated reference file, wherein said updated reference file contains less user specific information than said initial reference file;
(d) transmitting sufficient information to generate said updated reference file and a response to a current query to a specific user belonging to said plurality of users; and
(e) responding to a second query from said specific user by supplying a differences file so that a second response file may be generated from said updated reference file;
wherein said updated reference file serves as said initial reference file for a subsequent request.

13. The system of claim 12, wherein said initial reference file is defined by identifying information common to responses to at least two queries.

14. The system of claim 12, wherein said updated reference file is devoid of user specific information.

15. The system of claim 12, wherein said sufficient information includes said updated reference file and a differences file.

16. The system of claim 12, wherein sufficient information includes said response to a current query and a differences file, wherein said updated reference file is generatable therefrom.
